(19) United States
(12) Patent Application Publication
(10) Pub. No.: US 2024/0384685 A1
(43) Pub. Date: Nov. 21, 2024

(54) CANTILEVER NOZZLE WITH MODAL NATURAL FREQUENCY TUNING FEATURE

(71) Applicant: Pratt & Whitney Canada Corp., Longueuil (CA)

(72) Inventor: Anthony Salconi, Longueuil (CA)

(21) Appl. No.: 18/318,011

(22) Filed: May 16, 2023

(51) Int. Cl. F02C 7/06

(52) U.S. Cl. CPC F02C 7/06; F05D 2230/60; F05D 2240/128; F05D 2260/98

(57) ABSTRACT

A lubrication nozzle for a turbine engine includes a flange portion that includes a first thickness between a fastener surface and a mounting surface and a second thickness between a step surface and the mounting surface. The step surface is disposed about a conduit portion and the second thickness is tailored to tune a natural frequency to reduce vibrational excitations during operation while maintaining uniform mounting features for ease of assembly.

### TECHNICAL FIELD

The present disclosure relates generally to a cantilevered lubricant nozzle and more specifically to a cantilever nozzle with features for tuning a modal natural frequency.

### BACKGROUND

Turbine engines include lubrication systems that may include nozzle assemblies to direct lubricant onto rotating components, seal assemblies and/or part interfaces. The nozzle assembly may be mounted and orientated such that a nozzle portion is cantilevered outward a distance from a support structure. The overhung mass of the nozzle portion may generate dynamic vibratory responses and resonances. Excessive vibratory responses and resonances can limit the operational life of engine components.

### SUMMARY

A lubrication nozzle for a turbine engine, according to an exemplary embodiment of this disclosure includes, among other possible things, a flange portion including a first thickness between a mounting surface spaced apart from a fastener surface. The flange portion further includes a second thickness between a step surface and the mounting surface. The second thickness is greater than the first thickness. A conduit portion extends outward from the flange portion and defines a fluid passage between an inlet portion and a nozzle portion at a distal end. The step surface is disposed about the conduit portion. The nozzle portion is supported at the distal end of the conduit portion and is configured to receive a fluid flow through the fluid passage.

A lubrication system for a turbine engine assembly, according to another exemplary embodiment of this disclosure includes, among other possible things, a support member that is arranged proximate to a lubricant receiving member and a lubricant nozzle that is mounted to the support member with at least one fastener. The lubricant nozzle includes a flange portion with a first thickness between the mounting surface and a fastener surface. The flange portion further includes a second thickness between a step surface and the mounting surface. The second thickness is greater than the first thickness. A conduit portion defines a fluid passage from an inlet portion and a distal end. The step surface is disposed about the conduit portion. A nozzle portion is supported at the distal end of the conduit portion. The nozzle potion is configured to direct fluid received through the fluid passage onto the lubricant receiving member. A lubricant passage is in fluid communication with the inlet portion.

A method of forming a lubricant nozzle according to another exemplary embodiment of this disclosure includes, among other possible things, forming a nozzle portion disposed at a distal end of a conduit portion extending from a flange portion. Forming the flange portion includes forming a first thickness between a mounting surface and a fastener surface and forming a step surface on the flange portion about the conduit portion to include a second thickness between the mounting surface and the step surface. The method further includes adjusting a natural frequency of the nozzle assembly to a predefined value by forming the second thickness to be between 20% and 90% thicker than the first thickness.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example turbine engine.

FIG. 2 is schematic view of an example lubrication system and a portion of the example turbine engine.

FIG. 3 is a side view of an example lubrication nozzle assembly embodiment.

FIG. 4 is a front view of the example lubrication nozzle assembly embodiment of FIG. 3.

FIG. 5 is a side view of another example lubrication nozzle assembly embodiment.

FIG. 6 is a front view of the example lubrication nozzle assembly embodiment of FIG. 5.

### DETAILED DESCRIPTION

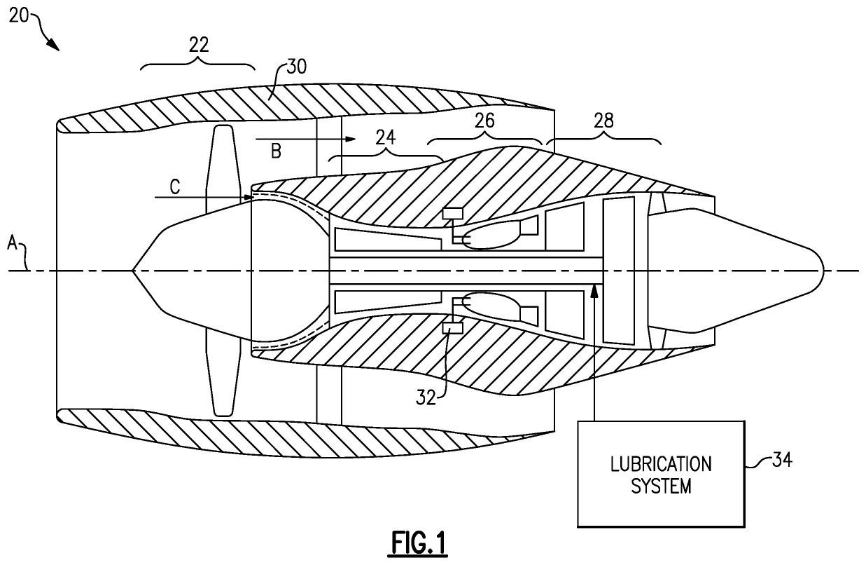

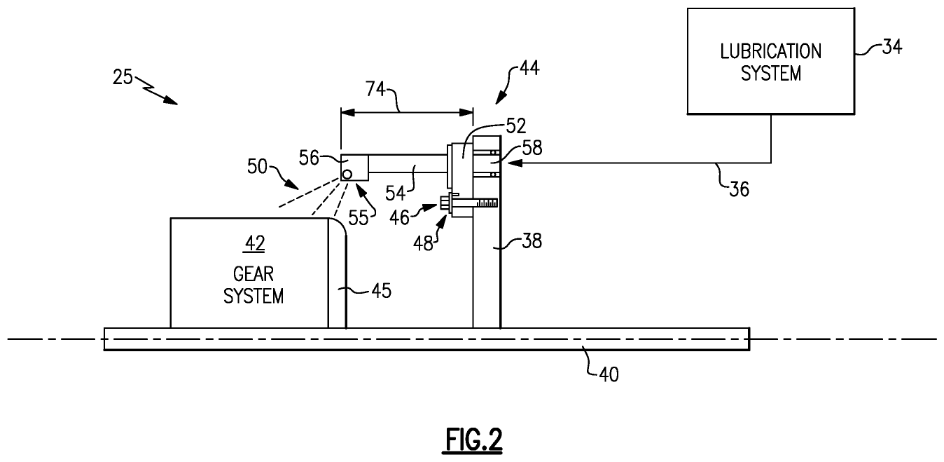

FIGS. 1 and 2 schematically illustrate a turbine engine 20 and a lubrication system 34 that includes at least one lubrication nozzle assembly 44 (FIG. 2). The example nozzle assembly 44 includes tailorable features for tuning a natural frequency for reducing vibrational excitations during operation while maintaining uniform mounting features to ease assembly.

The example turbine engine 20 is a turbofan that generally incorporates a fan section 22, a compressor section 24, a combustor section 26 and a turbine section 28 disposed along an engine longitudinal axis A. The fan section 22 drives air along a bypass flow path B in a bypass duct defined within a nacelle 30. The compressor section 24 drives air along a core flow path C into the compressor section 24 for compression and communication into the combustor section 26. In the combustor section 26, the compressed air is mixed with fuel from a fuel system 32 and burnt to generate an exhaust gas flow that expands through the turbine section 28 to generate shaft power.

Although depicted as a turbofan turbine engine in the disclosed non-limiting embodiment, it should be understood that the concepts described herein are not limited to use with turbofans as the teachings may be applied to other types of turbine engines including, for example, turboprop engines, turboshaft engines, and auxiliary power unit engines. Moreover, although turbine engines are described by way of example, other engine configurations such as internal combustion engines are within the contemplation of this disclosure.

Referring to FIG. 2, a rotating portion 25 associated with the example turbine engine 20 is schematically shown and includes a gear system 42 supported on a shaft 40 rotatable about an axis and a seal assembly 45. The example portion of the engine 20 may be part of gear reduction system, an accessory gearbox, a seal assembly or any other component or location that requires lubrication. Although a gear system 42 and seal assembly 45 are schematically shown by way of example, the example nozzle assembly 44 may be mounted in other locations requiring a spray of lubricant during operation.

The nozzle assembly 44 is mounted to a support member 38 that is proximate the gear system 42. The support member 38 may be part of a housing, cover, engine casing or any other static structure of the engine 20. The nozzle assembly 44 receives a lubricant flow 36 through an inlet portion 58 from the lubrication system 34 and provides a lubricant spray 50 to the gear system 42. The lubricant nozzle assembly 44 is mounted to the support member 38 with a fastener 46 secured in place with a tab washer 48. The tab washer 48 is provided as a securement feature to prevent the fastener 46 from working loose. Although a threaded fastener is shown and described by way of example, other fastener configurations could be utilized an are within the contemplation of this disclosure.

The nozzle assembly 44 includes a nozzle portion 56 supported on a distal end 55 of a conduit portion 54. The conduit portion 54 extends from a flange portion 52 that is secured to the support member 38 by the fastener 46.

The disclosed nozzle assembly 44 is a one-piece unitary part. Accordingly, the flange portion 52, the conduit portion 54, the nozzle portion 56 and the inlet portion 58 are all portions of a common structure formed as a one-piece part. However, the features of this disclosure may be applied to a multi-piece nozzle assembly are remain within the contemplation and scope of this disclosure.

The nozzle portion 56 is spaced apart from the support member 38 a distance 74. The nozzle portion 56 is an overhung mass that is supported in a cantilever manner and experiences dynamic vibrations and/or resonances. The overhung configuration of the nozzle assembly 44 has a fundamental natural frequency and mode shape. Some engine operating conditions may generate vibrations that excite and magnify the natural frequency of the nozzle assembly 44. The resulting oscillations may affect component durability and structural integrity. Accordingly, the example nozzle assembly 44 includes features for adjusting modal natural frequencies to a predetermined value that avoids interference and resonance engine operation while remaining within assembly constraints and without altering mounting structures.

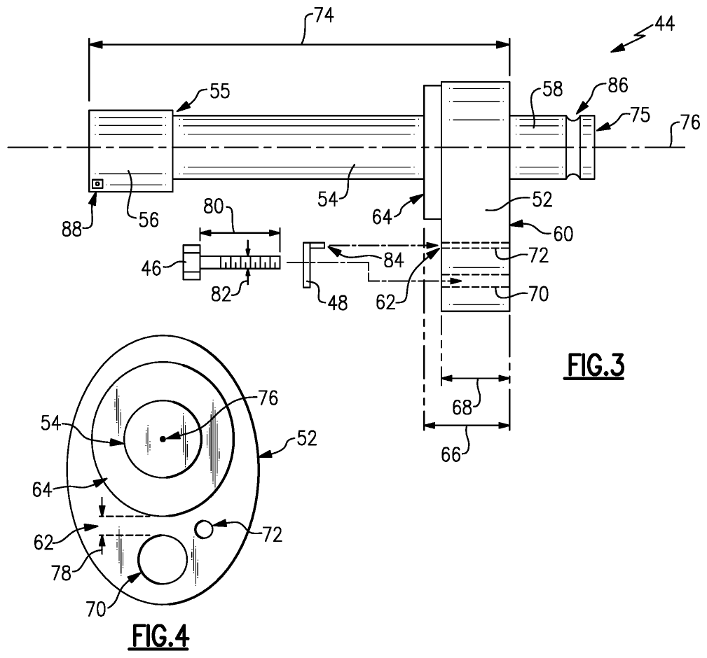

Referring to FIGS. 3 and 4, the example nozzle assembly 44 includes the flange portion 52 with a fastener surface 62 that is spaced apart from a mounting surface 60 a first thickness 68. The inlet portion 58 extends outward from the mounting surface 60 in a direction opposite the conduit portion 54. The conduit portion 54 and the inlet portion 58 are centered along an axis 76 and are hollow to define a passage 75 for communicating lubricant to the nozzle portion 56. The nozzle portion 56 is disposed at the distal end 55 of the conduit portion 54 and includes an outlet 88 for spraying lubricant. The inlet portion 58 includes an annular groove 86 for an O-ring or other sealing member.

The example flange portion 52 is non-symmetrical about the axis 76 centered along the conduit portion 54. A step surface 64 is disposed around the conduit portion 54. The step surface 64 is spaced apart from the mounting surface 60 a second thickness 66 that is greater than the first thickness 68. The additional material around the conduit portion 54 provided by the second thickness 66 of the step surface 64 increases stiffness to tune and define a natural frequency of the nozzle assembly 44. The second thickness 66 is sized to tailor the modal natural frequency of the nozzle assembly 44 to avoid interference and excitement from engine operation. The increased second thickness 66 increase stiffness of the conduit portion 54 for tailoring the natural frequency of the nozzle assembly 44.

The step surface 64 is spaced apart from a fastener opening 70 a distance 78 (FIG. 4). The distance 78 enables for the use of the prescribed fastener 46 due to the fastener surface 62 maintaining the first thickness 68. The distance 78 provides the space needed for a head of the fastener 46 to seat flat against the fastener surface 62. Accordingly, the distance 78 is set such that any rounding or chamfer provided to transition to the second thickness 66 of the step surface 64 does not interfere with the flat seating of the fastener 46 against the fastener surface 62.

As appreciated, although a thickness of the entire flange portion 52 could be increased to provide the desired increase in thickness, such an increase in thickness would require a corresponding change of a length 80 of the fastener 46. Changes to the length 80 of the fastener 46 would accordingly, need to follow every adaptation of the second thickness 66 for each different application as tailored for localized vibrational inputs. Many different fastener sizes for similar parts can cause complexity during assembly that is desired to be avoided.

The nozzle assembly 44 may be one of many that may be utilized within an engine or accessory device. Each nozzle assembly 44 is disposed at different locations that may be exposed to different vibrational inputs and therefore may require different thicknesses to define different natural frequencies. If the thickness of the entire flange for each different localized natural frequency was modified, then a different fastener size would be needed. Multiple different flange sizes and fastener sizes would complicate assembly.

The spaced apart distance 78 of the tailorable second thickness 66 of the step surface 64 of the disclosed example nozzle assembly 44 provides for tailoring of modal natural frequencies while maintaining commonality of the fastener size.

The fastener surface 62 is parallel to the mounting surface 60 and spaced apart from the mounting surface 60 the first thickness 68. The first thickness 68 is maintained in the area around the fastener opening 70. The common first thickness 68 is set as a common size to correspond with the size of the fastener 46.

The second thickness 66 between the mounting surface 60 and the step surface 64 is determined to provide a desired natural frequency that is not excited by operating conditions. In one example embodiment, the second thickness 66 is between 20% and 90% greater than the first thickness 68. In another example embodiment, the second thickness is between 20% and 45% greater than the first thickness 68. In still another example embodiment, the second thickness is around 15% and 30% greater than the first thickness 68. Although example relative thickness ranges are provided by way of example, other relative thickness ranges are within the contemplation and scope of this disclosure.

The distance 78 between the step surface 64 and the fastener opening 70 across the fastener surface 62 enables the use of common fastener sizes regardless of the increased size of the second thickness 66 needed to tailor natural frequency of the nozzle assembly 44 as desired. In one example embodiment, the fastener 46 includes the length 80 and diameter 82 that correspond to a predefined common size for an engine, engine section or accessory location. Additionally, the example tab washer 48 includes the tab 84 that fits within the tab opening 72 and is also of a predefined common size and configuration that corresponds with the fastener 46. Accordingly, the natural frequency of the example nozzle assembly 44 may be tailored to provide a desired natural frequency and vibratory response for different operating conditions and locations while maintaining a commonality of fastener sizing.

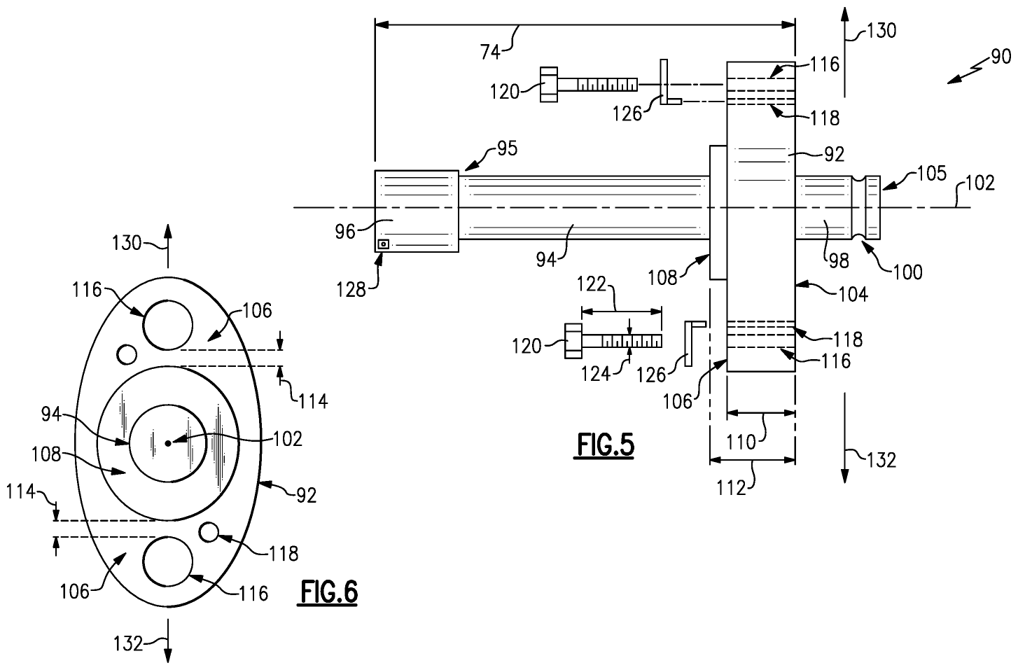

Referring to FIGS. 5 and 6, another example nozzle assembly 90 is shown and includes a flange portion 92 that extends outward from a longitudinal axis 102 centered along a conduit portion 94. The flange portion 92 extends outward in a first direction 130 and a second direction 132. A fastener opening 116 and tab opening 118 are disposed on either side of the conduit portion 94. The conduit portion 94 is hollow and defines a fluid passage 105 between an inlet portion 98 and a nozzle portion 96 at a distal end 95.

A step surface 108 surrounds the conduit portion 94 and is spaced apart from each of the fastener openings 116 by a distance 114 (FIG. 6). The step surface 108 is parallel to a mounting surface 104 and a fastener surface 106. A first thickness 110 between the fastener surface 106 and the mounting surface 104 is less than a second thickness 112 between the step surface 108 and the mounting surface 104. The second thickness 112 provides an increased stiffness of the conduit 94. The magnitude of stiffness can be tailored by adjusting the second thickness 112. Tailoring of the stiffness provides a means of setting the natural frequency of the nozzle assembly 90.

The inlet portion 98 and conduit portion 94 are hollow and define a passage for lubricant flow to a nozzle portion 96. The nozzle portion 96 includes an outlet 128 for spraying lubricant. The example inlet portion 98 includes an annular groove 100 for a seal such as an O-ring.

The disclosed nozzle assembly 90 is a one-piece unitary part. Accordingly, the flange portion 92, the conduit portion 94, the nozzle portion 96 and the inlet portion 98 are all portions of a common structure formed as a one-piece part.

The second thickness 112 between the mounting surface 104 and the step surface 108 is determined to provide a desired natural frequency that is not excited by engine operating conditions. In one example embodiment, the second thickness 108 is between 20% and 90% greater than the first thickness 110. In another example embodiment, the second thickness 112 is between 20% and 45% greater than the first thickness 110. In still another example embodiment, the second thickness 112 is around 15% and 30% greater than the first thickness 110. Although example relative thickness ranges are provided by way of example, other relative thickness ranges are within the contemplation and scope of this disclosure.

Adjustment of the second thickness 112 to the step surface 108 leaves the fastening surface 106 at the first thickness 110. The first thickness 110 provides for use of a uniform size of fastener 120 with a set length 122 and diameter 124. The use of the uniform size fastener 120 also provides for use of a common size tab washer 126. It should be appreciated, that the size of the fastener 120 and tab washer 126 may be of any determined size for a mounting location. The term uniform and common with regard to the fastener 120 in this disclosure includes sizes that are standardized for engine assembly to reduce complexity.

In one example disclosed embodiment, with reference to FIGS. 3-6, the example nozzle assemblies 44, 90 according to this disclosure is formed by determining a natural frequency of a nozzle assembly design including a conduit portion 54, 94 extending from a flange portion 52, 92 to a nozzle portion 56, 96.

The natural frequency of the initial nozzle assembly design can be determined utilizing known procedures, modeling systems and calculation methods. The natural frequency of the example nozzle assemblies 44, 90 is determined, in-part, by the mass of the nozzle portion 56, 96 cantilevered at the distal end 55, 95 of the conduit portion 54, 94. The natural frequency is further a result of the stiffness of the overall nozzle assembly 44, 90. The mass of the nozzle portion 56, 96 will vary depending on the specific nozzle shape and size and on the length of the conduit portion 54, 94 from the flange portion 52, 92.

Once the natural frequency of the nozzle assembly 44, 90 is determined, sources of vibrational energy input into the nozzle assembly 44, 90 are reviewed and analyzed to identify potential excitement possibilities. The vibrational energy inputs are determined for operating conditions and compared to the determined natural frequency of the nozzle assembly to understand if excitation outside of desired ranges are possible.

Once the vibrational energy inputs proximate the nozzle assembly 44, 90 are understood, the second thickness 66, 112 of the step surface 64, 108 may be adjusted to tailor modal frequencies of the nozzle assembly to provide a desired natural frequency that is determined to not present possible excitation. The proportion of the second thickness 66, 112 of the step surface 64, 108 relative to the first thickness 68, 110 is set to tune the natural frequency to a predefined value. In one example embodiment, the predefined value is the frequency that is determined not to create or contribute to an undesired frequency response during operation.

In one example embodiment adjusting the second thickness includes adjusting the second thickness 66, 112 to be between 20% and 90% thicker than the first thickness 68, 110. In another example embodiment, the second thickness 66, 112 is between 20% and 45% greater than the first thickness 68, 110. In still another example embodiment, the second thickness 66, 112 is around 15% and 30% greater than the first thickness 68, 110. Although example relative thickness ranges are provided by way of example, other relative thickness ranges are within the contemplation and scope of this disclosure.

Forming of the nozzle assembly 44, 90 further includes forming at least one opening 70, 116 through the fastener surface 62, 106 for a fastener 46, 120 and spacing the opening 70, 116 from the increased second thickness 66, 112. The fastener opening 70, 116 is spaced from the step surface 64, 108 such that a common fastener can be utilized while also providing for tailoring of a stiffness to adjust the natural frequency.

In one example, forming of the nozzle assembly 44, 90 comprises forming the flange portion 52, 92, the conduit portion 54, 94, and the nozzle portion 56, 96 as a one-piece unitary part. The nozzle assembly 44, 90 may be formed utilizing casting, molding and or machining processes from material suitable for the temperatures and pressures encountered for a specific application. In one example embodiment, the nozzle assembly 44, 90 is formed as a cast metal part. The cast metal part provides a general shape and features that are machined to provide desired specific shapes and dimensions. Moreover, the step surface 64, 108 may be formed form a secondary machining step to tailor the second thickness 66, 112 to provide the desired stiffness to set the natural frequency.

The disclosed example nozzle assemblies 44, 90 have specific features and components however, embodiments of this disclosure are not limited to those particular combinations. It is possible to use some of the components or features from one of the examples in combination with features or components from another one of the examples.

A lubrication nozzle 44, 90 for a turbine engine, according to an exemplary embodiment of this disclosure includes, among other possible things, a flange portion 52, 92 that includes a first thickness 68, 110 between a mounting surface 60, 104, and a fastener surface 62, 106 and a second thickness between 66, 112 between a step surface 64, 108 and the mounting surface 60, 104. The second thickness 66, 112 is greater than the first thickness 68, 110. A conduit portion 54, 94 extends outward from the flange portion 52 and defines a fluid passage 36, 92 from an inlet portion 58, 98 to a distal end. The step surface 64, 108 is disposed about the conduit portion 54, 94. A nozzle portion 56, 96 is supported at the distal end of the conduit portion 54 94.

In a further embodiment of the foregoing lubrication nozzle 44, 90, the inlet portion 58, 98 extends outward from the mounting surface 60, 104 in a direction opposite the conduit portion 54, 94.

In a further embodiment of any of the foregoing lubrication nozzles 44, 90, the step surface 64, 108 is parallel to the mounting surface 60, 104.

In a further embodiment of any of the foregoing lubrication nozzles 44, 90, the fastener surface 62, 106 includes at least one opening 70, 116 for a fastener 46, 120.

In a further embodiment of any of the foregoing lubrication nozzles 44, 90, the step surface 64, 108 is spaced apart from the at least one opening 70, 116 for a fastener 46, 120.

In a further embodiment of any of the foregoing lubrication nozzles 44, 90, the second thickness 66, 112 is between 20% and 90% thicker than the first thickness 68, 110.

In a further embodiment of any of the foregoing lubrication nozzles 44, 90, the second thickness 66, 112 is between 20% and 45% thicker than the first thickness 68, 110.

In a further embodiment of any of the foregoing lubrication nozzles 44, 90, the second thickness 66, 112 is between 15% and 30% thicker than the first thickness 68, 110.

In a further embodiment of any of the foregoing lubrication nozzles 44, 90, the flange portion 52, 92 is non-symmetrical about a longitudinal axis 76, 102 that is centered along the conduit portion 54, 94.

In a further embodiment of any of the foregoing lubrication nozzles 44, 90 the flange portion 52, 92 extends outward from a longitudinal axis 76, 102 that is centered along the conduit portion 54, 94 in a first direction 130 and a second direction 132.

A lubrication system 34 for a turbine engine assembly 20, according to another exemplary embodiment of this disclosure includes, among other possible things, a support member 38 that is arranged proximate to a lubricant receiving member 42 and a lubricant nozzle 44, 90 that is mounted to the support member 38 with at least one fastener 46, 120. The lubricant nozzle 44, 90 includes a flange portion 52, 92 that includes a first thickness 68,110 between a fastener surface 62, 106 and a mounting surface 60, 104. The flange portion 52, 92, further includes a second thickness 66, 112 between a step surface 60, 104 and the mounting surface 60, 104. The second thickness 66, 112 is greater than the first thickness 68, 110. A conduit portion 54, 94 defines a fluid passage between an inlet portion 58, 98 and a distal end. The step surface 64, 108 is disposed about the conduit portion 54, 94. A nozzle portion 56, 96 is supported at the distal end of the conduit portion 54, 94. A lubricant passage 36 is in fluid communication with the inlet portion 58, 98.

In a further embodiment of the foregoing lubrication system 34, the step surface 64, 108 is parallel to the mounting surface 60, 104.

In a further embodiment of any of the foregoing lubrication systems, the fastener surface 62, 106 includes at least one opening 70, 116 for a fastener 46, 120 and at least one opening 72, 118 for a tab washer 48, 126.

In a further embodiment of any of the foregoing lubrication systems 34, the step surface 64, 108 is spaced apart from the at least one opening for the fastener 46 or 120.

In a further embodiment of any of the foregoing lubrication systems 34, the second thickness 66, 112 is between 20% and 90% thicker than the first thickness 68, 110.

In a further embodiment of any of the foregoing lubrication systems 34, the flange portion 52, 92, the conduit portion 54, 94 and the nozzle portion 56, 96 comprise an integral one-piece part.

A method of forming a lubricant nozzle according to another exemplary embodiment of this disclosure includes, among other possible things forming a nozzle portion 56, 96 at a distal end of a conduit 54, 94 that extends from a flange portion 52, 92. Forming of the flange portion 52, 92 includes forming a first thickness 68, 110 between a mounting surface and a fastener surface and forming a step surface on the flange portion about the conduit portion to includes a second thickness between the mounting surface and the step surface. The method further includes adjusting a natural frequency to a predefined value by forming the second thickness 66, 112 to be between 20% and 90% thicker than the first thickness 68, 110.

In a further embodiment of the foregoing, the method further includes the step of forming at least one opening 70, 116 through the fastener surface 62, 106.

In a further embodiment of the foregoing, the method further includes forming the flange portion 52, 92, the conduit portion 54, 94 and the nozzle portion 56, 96 as an integral one-piece unitary part.

In a further embodiment of the foregoing, the method further includes making the second thickness 66, 112 between 20% and 45% thicker than the first thickness 68, 110.

Accordingly, the disclosed example nozzle assemblies 44, 90 include tailorable features for preventing vibrational excitations during operation while maintaining uniform mounting features to ease assembly.

Although an example embodiment has been disclosed, a worker of ordinary skill in this art would recognize that certain modifications would come within the scope of this disclosure. For that reason, the following claims should be studied to determine the scope and content of this disclosure.

1. A lubrication nozzle for a turbine engine, the lubrication nozzle comprising:
a flange portion including a first thickness between a mounting surface and a fastener surface and a second thickness between a step surface and the mounting surface, wherein the second thickness is greater than the first thickness;
a conduit portion extending outward from the fastener surface of the flange portion to an end distal from the fastener surface;
an inlet portion extending from the mounting surface of the flange portion in a direction opposite the conduit portion, wherein a fluid passage is defined from the inlet portion to the end of the conduit portion distal from the fastener surface and the step surface is disposed about the conduit portion; and
a nozzle portion supported at the distal end of the conduit portion and configured to receive a fluid flow through the fluid passage.

2. (canceled)

3. The lubrication nozzle as recited in claim 1, wherein the step surface is parallel to the mounting surface.

4. The lubrication nozzle as recited in claim 3, wherein the fastener surface includes at least one opening for a fastener.

5. The lubrication nozzle as recited in claim 4, wherein the step surface is spaced apart from the at least one opening for a fastener.

6. The lubrication nozzle as recited in claim 3, wherein the second thickness is between 20% and 90% thicker than the first thickness.

7. The lubrication nozzle as recited in claim 3, wherein the second thickness is between 20% and 45% thicker than the first thickness.

8. The lubrication nozzle as recited in claim 3, wherein the second thickness is between 15% and 30% thicker than the first thickness.

9. The lubrication nozzle as recited in claim 1, wherein the flange portion is non-symmetrical about a longitudinal axis centered along the conduit portion.

10. The lubrication nozzle as recited in claim 1, wherein the flange portion extends outward from a longitudinal axis centered along the conduit portion in a first direction and a second direction.

11. A lubrication system for a turbine engine assembly, the lubrication system including:
a support member arranged proximate to a lubricant receiving member;
a lubricant nozzle mounted to the support member with at least one fastener, the lubricant nozzle including;
a flange portion including a first thickness between a mounting surface spaced apart from a fastener surface and a second thickness between a step surface spaced apart from the mounting surface, wherein the second thickness is greater than the first thickness;
a conduit portion extending outward from the fastener surface of the flange portion to an end distal from the fastener surface;
an inlet portion extending from the mounting surface of the flange portion in a direction opposite the conduit portion, wherein a fluid passage is defined from the inlet portion to the end of the conduit portion distal from the fastener surface, wherein the step surface is disposed about the conduit portion; and
a nozzle portion supported at the distal end of the conduit portion, the nozzle portion configured to direct fluid received through the fluid passage onto the lubricant receiving member; and
a lubricant passage in fluid communication with the inlet portion.

12. The lubrication system as recited in claim 11, wherein the step surface is parallel to the mounting surface.

13. The lubrication system as recited in claim 12, wherein the fastener surface includes at least one opening for a fastener and at least one opening for a tab washer.

14. The lubrication system as recited in claim 13, wherein the step surface is spaced apart from the at least one opening for the fastener.

15. The lubrication system as recited in claim 11, wherein the second thickness is between 20% and 90% thicker than the first thickness.

16. The lubrication system as recited in claim 11, wherein the flange portion, the conduit portion and the nozzle portion comprise an integral one-piece part.

17. A method of forming a lubricant nozzle comprising:
forming a nozzle portion disposed at a distal end of a conduit portion extending from a flange portion, wherein forming the flange portion includes forming a first thickness between a mounting surface and a fastener surface and forming a second thickness between a step surface and the mounting surface on the flange portion about the conduit portion;
forming an inlet portion that extends outward from a side of the flange opposite the conduit portion that includes a portion of a fluid passage that extends to the distal end of the conduit portion; and
adjusting a natural frequency of the nozzle assembly to a predefined value by forming the second thickness to be between 20% and 90% thicker than the first thickness.

18. The method as recited in claim 17, further comprising the step of forming at least one opening through the fastener surface.

19. The method as recited in claim 17, further comprising forming the flange portion, the conduit portion, and the nozzle portion as an integral one-piece unitary part.

20. The method as recited in claim 17, further comprising making the second thickness between 20% and 45% thicker than the first thickness.
